(19) United States
(12) Patent Application Publication
(10) Pub. No.: US 2003/0025310 A1
(43) Pub. Date: Feb. 6, 2003

(54) Air bag operation control system

(76) Inventor: Akinori Jitsui, Okazaki-shi (JP)

Correspondence Address: LAW OFFICES OF DAVID G. POSZ, 2000 L STREET, N.W., SUITE 200, WASHINGTON, DC, 20036, US

(21) Appl. No.: 10/206,070

(22) Filed: Jul. 29, 2002

(30) Foreign Application Priority Data
Aug. 1, 2001 (JP) 2001-233071

(51) Int. Cl. B60R 21/32

(52) U.S. Cl. 280/735; 280/804

(57) ABSTRACT

An airbag operation control system controls inflation of an air bag and has discrimination data (map) for classifying the load and the tensile force into first and second groups (adult and child), classifies the load and the tensile force. When the load and the tensile force is classified into the first group, the system measures a duration for which the load and the tensile force continuously classified into the first group and makes judgment whether inflation of the air bag is permitted (adult case) or inhibited (child case) if the time duration exceeds a predetermined interval to supply a control signal to the air bag.

### BACKGROUND OF THE INVENTION

1. Field of the Invention

This invention relates to an air bag operation control system, and particularly to an air bag operation control system for controlling inflation of an air bag on the basis of a seat load and a seat belt tensile force.

2. Description of the Prior Art

Air bag operation control systems for controlling the inflation of an air bag in a motor vehicle are known. Japanese patent application provisional publication No. 20000-29657 discloses a technique for controlling the operation of an air bag, wherein it is judged whether the inflation of the air bag is permitted or inhibited by comparing the detection value from a seat load detection means for detecting a load on a seat with a threshold value, and the threshold value is increased in accordance with the detected tensile force in a seat belt.

However, this prior art system may make an erroneous judgment of permitting the operation of the air bag. For example, when an adult passenger sits on the seat and the brake pedal is depressed while the motor vehicle travels, the adult passenger shifts forwardly on the seat. Then, there is a possibility that the tensile force in the seat belt increases, but the load on the seat decreases. In this case, because the threshold value is increased in accordance with the tensile force of the seat belt, the load detected by the seat load detection means becomes lower than the threshold value. Thus, the operation of the airbag may be inhibited, although an adult passenger sits on the seat. This provides an erroneous judgment. Therefore, it is required to provide an air bag operation control system capable of more accurate judgment as to whether the operation of the air bag is permitted or inhibited.

### SUMMARY OF THE INVENTION

The object of the present invention is to provide a superior air bag operation control system.

The related object of the present invention is to provide a superior air bag operation control system capable of more accurate judgment as to whether the operation of the air bag is permitted or inhibited.

According to the present invention, a first aspect of the present invention provides an airbag operation control system for a motor vehicle comprising:

seat load detection means for detecting a load on a seat in said motor vehicle;

seat belt load detection means for detecting a tensile force in a seat belt in said motor vehicle; and

control means for controlling inflation of an airbag in said motor vehicle, wherein

said control means includes a map storing data for classifying a passenger sitting on said seat into A and B regions of said map in accordance with values of said load on said seat and said tensile force in said seat belt, classifying said passenger into said A region indicating that said passenger is an adult, and wherein

said control means measures a time duration for which said passenger is continuously classified into said A region when said passenger is classified into said A region, and permits said air bag to inflate when said time duration exceeds a predetermined interval TAth.

According to the present invention, a second aspect of the present invention provides an airbag operation control system for a motor vehicle comprising:

seat load detection means for detecting a load on a seat in said motor vehicle;

seat belt load detection means for detecting a tensile force in a seat belt in said motor vehicle; and

control means for controlling inflation of an airbag in said motor vehicle, wherein

said control means includes a map storing data for classifying a passenger sitting on said seat into A and B regions of said map in accordance with values of said load on said seat and said tensile force in said seat belt, classifying said passenger into said A region indicating that said person is an adult, and wherein

said control means measures a time duration for which said passenger is continuously classified into said B region when said passenger is classified into said B region, and inhibits said air bag from inflating when said time duration exceeds a predetermined interval TBth.

According to the present invention, a third aspect of the present invention provides an airbag operation control system based on said first aspect, wherein said control means measures a time duration for which said passenger is continuously classified into said B region when said passenger is classified into said B region, and inhibits said air bag from inflating when said time duration exceeds a predetermined interval TBth.

According to the present invention, a fourth aspect of the present invention provides an airbag operation control system for a motor vehicle comprising:

seat load detection means for detecting a load on a seat in said motor vehicle;

seat belt load detection means for detecting a tensile force in a seat belt in said motor vehicle; and

control means for controlling inflation of an air bag in said motor vehicle, wherein said control means has discrimination data for classifying a passenger sitting on said seat in accordance with said load and said tensile force into first and second groups, and classifies said passenger in accordance with said load and said tensile force, and wherein when said load and said tensile force is classified into said first group, said control means measures a time duration for which said load and said tensile force continuously classified into said first group and makes judgment whether inflation of said air bag is permitted or inhibited when said time duration exceeds a predetermined interval to supply a control signal to said air bag.

According to the present invention, a fifth aspect of the present invention provides an airbag operation control system based on the fourth aspect, wherein said control means permits said air bag to inflate, when said time duration exceeds a predetermined interval.

According to the present invention, a sixth aspect of the present invention provides an airbag operation control system based on the fourth aspect, wherein said control means inhibits said air bag from inflating, when said time duration exceeds a predetermined interval.

According to the present invention, a seventh aspect of the present invention provides an airbag operation control system based on the fourth aspect, wherein said load and said tensile force obtained when said passenger is classified into said first group correspond to load and tensile force obtained from said load detection means and said seat belt load detection means when a passenger sitting on said seat is an adult, and wherein said control means permits said air bag to inflate, when said time duration exceeds a predetermined interval.

According to the present invention, an eighth aspect of the present invention provides an airbag operation control system based on the fourth aspect, wherein said load and said tensile force obtained when said passenger is classified into said second group correspond to load and tensile force obtained from said load detection means and said seat belt load detection means when a passenger sitting on said seat is a non-adult, and wherein said control means inhibits said air bag from inflation, when said time duration exceeds a predetermined interval.

According to the present invention, a ninth aspect of the present invention provides an airbag operation control system based on the fourth aspect, wherein said control means has a map as said discrimination data to classifying said passenger into A and B regions of said map as said first and second groups, thereby, said control means classifies said passenger in accordance with said load and said tensile force into said A and B regions.

According to the present invention, a tenth aspect of the present invention provides an airbag operation control system based on the fourth aspect, wherein said control means has at least a threshold value as said discrimination data.

According to the present invention, an eleventh aspect of the present invention provides an airbag operation control system based on the fourth aspect, wherein said control means has at least a reference function as said discrimination data.

### BRIEF DESCRIPTION OF THE DRAWINGS

The object and features of the present invention will become more readily apparent from the following detailed description taken in conjunction with the accompanying drawings in which:

FIG. 1 is an illustration of an air bag operation control system according to an embodiment of the present invention;

FIG. 2 is a block diagram of the air bag operation control system according to this embodiment;

FIGS. 3A to 3C are graphical drawings of a map for the discrimination operation according to this embodiment; and

FIG. 4 depicts a flow chart of air bag inflation inhibition/permission operation according to this embodiment.

The same or corresponding elements or parts are designated with like references throughout the drawings.

### DETAILED DESCRIPTION OF THE INVENTION

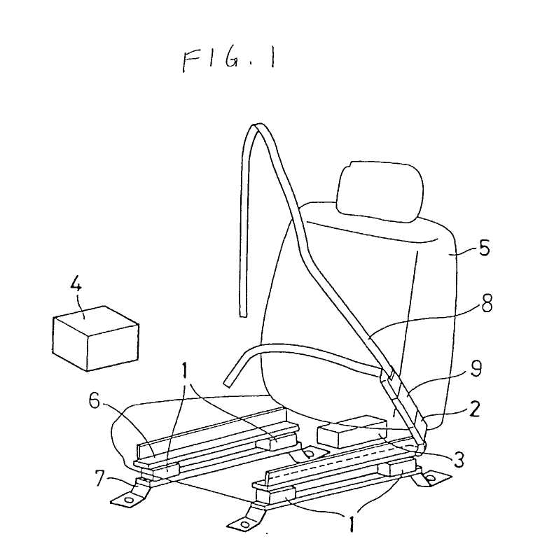

FIG. 1 illustrates an air bag operation (inflation) control system according to an embodiment of the present invention.

The air bag operation control system (apparatus) controls the operation (inflation) of an air bag (air bag unit) for a seat, such as an assistant driver's seat, in a motor vehicle. The air bag operation control system includes a seat load sensor 1, a seat belt load sensor 2, a passenger detection ECU (electronic control unit) 3, and an air bag ECU 4.

The seat load sensor 1 detects a load on a seat (hereinafter referred to as a seat load). In this embodiment, as shown in FIG. 1, four seat load sensors 1 are provided between the upper frame 6 and the lower frame 7.

The seat belt load sensor 2 detects a tensile force (hereinafter referred to as belt load) acting in the seat belt 8 and is mounted under a buckle 9 for receiving a tang plate of the seat belt 8.

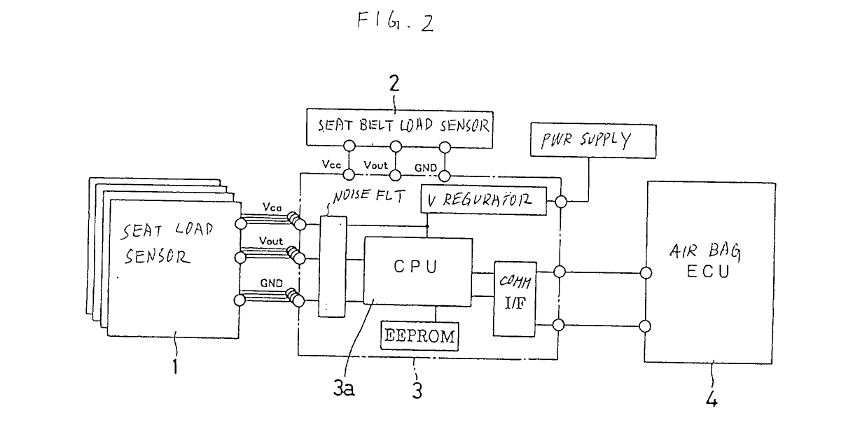

The passenger detection ECU 3, as shown in FIG. 2, comprises a CPU (central processing unit) 3a and judges whether the inflation of the air bag is permitted or inhibited on the basis of the seat load obtained from a sum of output values of four seat load sensors 1 and the sensor output of the seat belt load sensor 2 (belt load) to supply a control signal based on the judging result to an air bag ECU 4 as shown in FIG. 2.

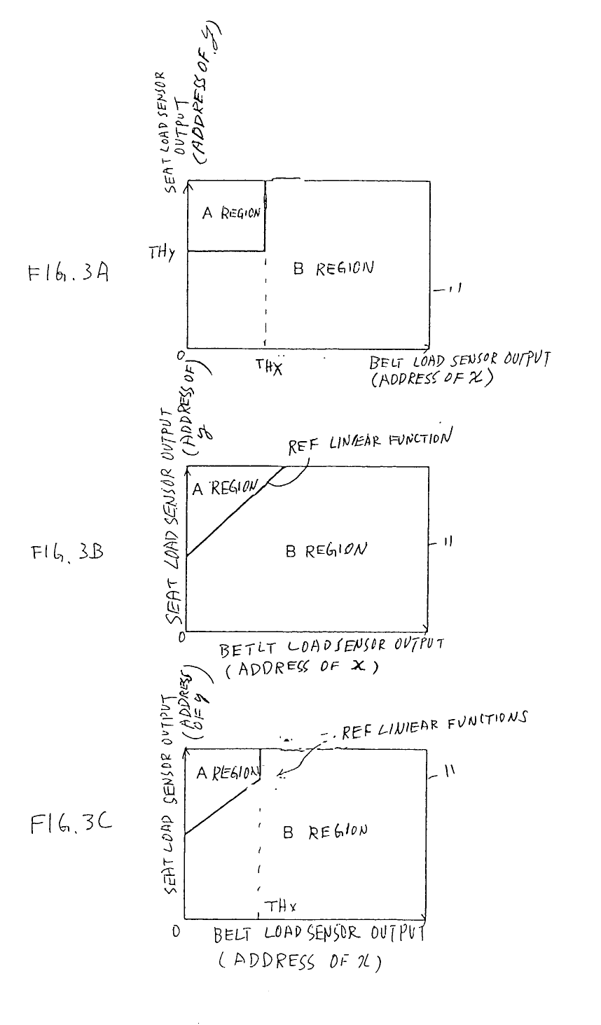

The passenger detection ECU 3 stores a relation between the seat load and the belt load in advance as a map (table) 11 having the region of the map 11 into A and B regions as shown in FIGS. 3A to 3C. The A region defines values of the seat load and the belt load as those obtained when an adult passenger sits on the seat. The passenger detection ECU 3 judges whether the inflation of the air bag is permitted or inhibited on the basis of the seat load and the sensor output of the seat belt load sensor 2 (belt load) with reference to the map 11 to supply the control signal based on the judging result to the air bag ECU 4.

The air bag ECU 4 controls the operation (inflation) of the air bag (air bag unit) on the basis of the control signal from the passenger detection ECU 3, that is, inflates the air bag when a crash is detected if the inflation is permitted. On the other hand, if the inflation is inhibited, the air bag ECU 4 does not operate the air bag unit on detection of a crash.

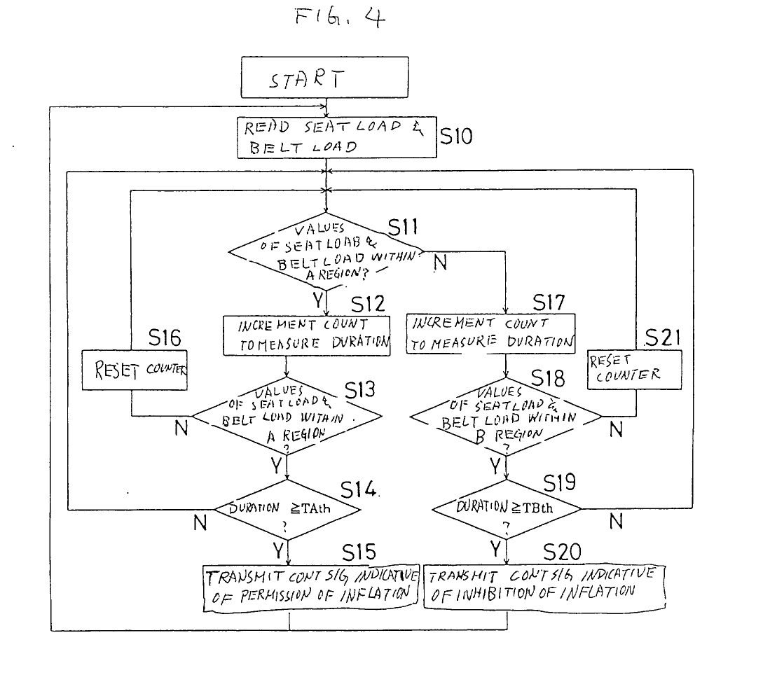

The process in the passenger detection ECU 3 will be described with reference to FIG. 4 illustrating a flow chart.

In step S10, the passenger detection ECU 3 reads the output of the seat load sensor 1 (seat load) and the output of the seat belt load sensor 2 (belt load).

In step S11, the passenger detection ECU 3 judges whether the relation between the output of the seat load sensor and the output of the seat belt load sensor 2 corresponds to the A region of the map 11 which have been stored in the passenger detection ECU 3. The passenger detection ECU 3 judges that the values of the detected belt load and the detected seat load are within the A region, and processing proceeds to step S12. If the passenger detection ECU 3 judges that the values of the detected belt load and the detected seat load are outside the A region, processing proceeds to step S17.

In step S12, the passenger detection ECU 3 measures the time duration for which that the values of the detected belt load and the detected seat load are continuously within the A region, by counting times of this processing executed, that is, by incrementing a time duration count. Since this process is executed periodically, counting the number of times of this process provides a time interval. In this case, a waiting step for measuring a predetermined interval may be provided on the route from step 14 to step 11 to provide an accurate operation.

In the following step S13, the passenger detection ECU 3 judges again whether the values of the detected belt load and the detected seat load are within the A region. If the values of the detected belt load and the detected seat load are within the A region, processing proceeds to step S14. If the values of the detected belt load and the detected seat load are outside the A region, processing proceeds to step S16.

In step S14, the passenger detection ECU 3 judges whether the time duration is larger or equal to a predetermined interval TAth. If the time duration (count) is larger or equal to a predetermined interval TAth (a predetermined value), processing proceeds to step S15. If the time duration is less than a predetermined interval TAth, processing returns to step S11.

In step S15, the passenger detection ECU 3 supplies the control signal indicative of permission of inflation of the air bag to the air bag ECU 4.

In step S16, that is, when the values of the detected belt load and the detected seat load are without the A region, the passenger detection ECU 3 resets the time duration (count) for initialization, and then, processing returns to step S11.

In step S17, that is, when the values of the detected belt load and the detected seat load are without the A region in step S11, the passenger detection ECU 3 increments the time duration count, and then, processing proceeds to step S18. Since this step is executed periodically, counting the number of times of this process provide a time interval. In this case, the waiting step for measuring a predetermined interval may be provided on the route from step 19 to step 11.

In step S18, the passenger detection ECU 3 judges whether the values of the detected belt load and the detected seat load are within the B region. If the values of the detected belt load and the detected seat load are within the B region, processing proceeds to step S19. If the values of the detected belt load and the detected seat load are without the B region (A region), processing proceeds to step S21.

In step 19, the passenger detection ECU 3 judges whether the time duration is larger or equal to a predetermined interval (value) TBth. If the time duration (count) is larger or equal to a predetermined interval TBth (value), processing proceeds to step S20. If the time duration is less than a predetermined interval TBth, processing returns to step S11.

In step S20, the passenger detection ECU 3 supplies the control signal indicative of inhibition of inflation of the air bag to the air bag ECU 4.

In step S21, that is, when the values of the detected belt load and the detected seat load are without the B region, the passenger detection ECU 3 resets the time duration (count) for initialization, and then, and processing returns to step S11.

According to this embodiment, it is judged whether the inflation of the air bag is permitted or inhibited with reference to judgment whether the time duration for which the values of the detected belt load and the detected seat load are within the A or B region, which prevents an erroneous judgment which may be caused by instant variation of the seat load and belt load. For example, when an adult passenger sits on the seat during driving, the values of the detected belt load and the detected seat load which are within the A region may shift to the B region instantaneously because of some reason such as braking. In this case, the inflation of the airbag is not inhibited as long as the time duration for which the values of the detected belt load and the detected seat load are within the B region exceeds the predetermined interval TBth. That is, this operation prevents erroneous inhibition of the inflation of the air bag caused by an erroneous judgment though an adult passenger sits on the seat.

On the other hand, while a passenger of a child (non-adult) sits on the seat during driving, or while a child seat on which an infant sits is fixed on the seat, the values of the detected belt load and the detected seat load which are within the B region may shift to the A region instantaneously because of some reason. In this case, the inflation of the airbag is not permitted as long as the time duration for which the values of the detected belt load and the detected seat load are within the A region exceeds the predetermined interval TAth. That is, this operation prevents erroneous permission of the inflation of the air bag caused by an erroneous judgment though a passenger of a child sits on the seat during driving, or while a child seat on which an infant sits is fixed on the seat.

As mentioned above, the system according to this embodiment prevents the erroneous judgment for permission and inhibition of the operation of the air bag, that is, the system can control operation of the air bag accurately, and thereby provides a sufficient reliability and safety.

As mentioned above, the airbag operation control system for a motor vehicle detects a load on a seat in the motor vehicle and detects a tensile force in a seat belt in the motor vehicle. The passenger detection ECU 3 controls inflation of an airbag in the motor vehicle.

The passenger detection ECU 3 includes the map (table) 11 storing data for classifying a passenger person sitting on the seat into A and B regions of the map in accordance with values of the load on the seat and the tensile force in the seat belt. The passenger is classified into the A region indicating that the person is an adult. The passenger detection ECU 3 measures a time duration for which the passenger is continuously classified into the A region when the passenger is classified into the A region, and permits the air bag to inflate if the time duration exceeds a predetermined interval TAth.

Moreover, the passenger detection ECU 3 measures a time duration for which the passenger is continuously classified into the B region when the passenger is classified into the B region, and inhibits the air bag from inflating when the time duration exceeds a predetermined interval TBth.

The classification or discrimination operation will be described more specifically.

The map 11 is defined such that the discrimination data of “0” (A region) and “1” (B region) are two-dimensionally arranged in accordance with x and y addresses. The discrimination data is read with reference to x and y addressees which are determined on the basis of the detected seat load and belt load. When the read discrimination data is “0”, the passenger is classified into the A region and judged to be an adult. When the read discrimination data is “1”, the passenger is classified into the B region and judged to be a non-adult.

In addition, such a discrimination operation can be provided by comparing the detected seat load and the detected belt load with threshold values THx and THy as shown in FIG. 3A and/or a reference linear function(s) as shown in FIGS. 3B and 3C.

In FIG. 3A, threshold values THx and THy can be used for classifying the values of the seat load and the belt load into two groups. More specifically, in the case of FIG. 3A, the passenger detection ECU 3 has threshold values THx and THy for defining the A and B regions. The detected belt load is compared with the threshold value THx, and the seat load is compared with the threshed value THy. If the detected belt load exceeds than the threshold value THx, and the detected seat load exceeds the threshed value THy, the passenger ECU 3 judges that the values of the detected belt load and the detected seat load are within the A region or the values of the detected belt load and the detected seat load corresponding to those obtained in the case of an adult.

In the cases of FIG. 3B, instead of threshold values, a reference liner function is used for judgment. In the cases of FIG. 3C, a plurality of reference liner functions are used.

In other words, the passenger detection ECU 3 has discrimination data for classifying the passenger on the seat into first and second groups in accordance with the load and the tensile force and classifies the passenger sitting on the seat in accordance with the detected load and tensile force. When the passenger is classified into the first group, the passenger detection ECU 3 measures a time duration for which the passenger is continuously classified into the first group, and makes judgment whether inflation of the air bag is permitted or inhibited if the time duration exceeds a predetermined interval to supply a control signal to the air bag. More specifically, the passenger ECU 3 permits the air bag to inflate, if the time duration exceeds an interval TAth because the passenger ECU 3 judged that the passenger is an adult.

Further, the passenger detection ECU 3 measures a second duration for which the passenger is continuously classified into the second group and inhibits the air bag from inflating, when the second duration exceeds an interval TBth because the passenger detection ECU 3 judged that the passenger is a non-adult.

What is claimed is:

1. An airbag operation control system for a motor vehicle comprising:
seat load detection means for detecting a load on a seat in said motor vehicle;
seat belt load detection means for detecting a tensile force in a seat belt in said motor vehicle; and
control means for controlling inflation of an airbag in said motor vehicle, wherein
said control means includes a map storing data for classifying a passenger sitting on said seat into A and B regions of said map in accordance with values of said load on said seat and said tensile force in said seat belt, classifying said passenger into said A region indicating that said passenger is an adult, and wherein
said control means measures a time duration for which said passenger is continuously classified into said A region when said passenger is classified into said A region, and permits said air bag to inflate when said time duration exceeds a predetermined interval TAth.

2. An airbag operation control system for a motor vehicle comprising:
seat load detection means for detecting a load on a seat in said motor vehicle;
seat belt load detection means for detecting a tensile force in a seat belt in said motor vehicle; and
control means for controlling inflation of an airbag in said motor vehicle, wherein
said control means includes a map storing data for classifying a passenger sitting on said seat into A and B regions of said map in accordance with values of said load on said seat and said tensile force in said seat belt, classifying said passenger into said A region indicating that said person is an adult, and wherein
said control means measures a time duration for which said passenger is continuously classified into said B region when said passenger is classified into said B region, and inhibits said air bag from inflating when said time duration exceeds a predetermined interval TBth.

3. The airbag inflation control system as claimed in claim 1, wherein said control means measures a time duration for which said passenger is continuously classified into said B region when said passenger is classified into said B region, and inhibits said air bag from inflating when said time duration exceeds a predetermined interval TBth.

4. An airbag operation control system for a motor vehicle comprising:
seat load detection means for detecting a load on a seat in said motor vehicle;
seat belt load detection means for detecting a tensile force in a seat belt in said motor vehicle; and
control means for controlling inflation of an air bag in said motor vehicle, wherein said control means has discrimination data for classifying a passenger sitting on said seat in accordance with said load and said tensile force into first and second groups, and classifies said passenger in accordance with said load and said tensile force, and wherein when said load and said tensile force is classified into said first group, said control means measures a time duration for which said load and said tensile force continuously classified into said first group and makes judgment whether inflation of said air bag is permitted or inhibited when said time duration exceeds a predetermined interval to supply a control signal to said air bag.

5. The airbag inflation control system as claimed in claim 4, wherein said control means permits said air bag to inflate, when said time duration exceeds a predetermined interval.

6. The airbag inflation control system as claimed in claim 4, wherein said control means inhibits said air bag from inflating, when said time duration exceeds a predetermined interval.

7. The airbag inflation control system as claimed in claim 4, wherein said load and said tensile force obtained when said passenger is classified into said first group correspond to load and tensile force obtained from said load detection means and said seat belt load detection means when a passenger sitting on said seat is an adult, and wherein said control means permits said air bag to inflate, when said time duration exceeds a predetermined interval.

8. The airbag inflation control system as claimed in claim 4, wherein said load and said tensile force obtained when said passenger is classified into said second group correspond to load and tensile force obtained from said load detection means and said seat belt load detection means when a passenger sitting on said seat is a non-adult, and wherein said control means inhibits said air bag from inflation, when said time duration exceeds a predetermined interval.

9. The airbag inflation control system as claimed in claim 4, wherein said control means has a map as said discrimination data to classifying said passenger into A and B regions of said map as said first and second groups, thereby, said control means classifies said passenger in accordance with said load and said tensile force into said A and B regions.

10. The airbag inflation control system as claimed in claim 4, wherein said control means has at least a threshold value as said discrimination data.

11. The airbag inflation control system as claimed in claim 4, wherein said control means has at least a reference function as said discrimination data.
